(19) United States
(12) Patent Application Publication
(10) Pub. No.: US 2009/0172994 A1
(43) Pub. Date: Jul. 9, 2009

(54) Bait retrieval assembly in live well for off-shore boat

(76) Inventors: Stepphen S. Sloop, Woodbine, GA (US); John Bruce Sloop, JR., Augusta, GA (US)

Correspondence Address: Alfred D. Lobo & Co., L.P.A., Suite #2, 2655 Euclid Hts. Blvd., Cleveland Hts., OH, 44106-2851, US

(21) Appl. No.: 12/006,663

(22) Filed: Jan. 4, 2008

(51) Int. Cl. A01K 97/05

(52) U.S. Cl. 43/57

(57) ABSTRACT

A live well for live bait is provided with a bait retrieval assembly of readily available structural components which are combined in an unexpectedly useful manner to allow all operations to be carried out using one hand only. The live well, which is typically closed with a substantially rigid cover, may be of arbitrary cross-section but is typically either cylindrical or rectangular, and in each case, tapered. The retrieval assembly includes a telescopable support member comprising plural telescopable cylinders; the innermost cylinder is capped and provided with a fastening means for a colander which is reciprocable on the support member. An electrically actuated fluid control system comprising a feed pump and valves pumps water into the support member and pressurizes it sufficiently to raise the innermost cylinder and the colander when a bait is to be selected. Flow of water to the support member is cut off when the colander is to be lowered into the well.

### FIELD OF THE INVENTION

This invention relates to a retrieval assembly in a “live well” for bait which is to be retrieved as the need arises. The live well is a “built-in” feature of a relatively large boat used for fishing. Water in the live well is optionally, preferably aerated to ensure that the bait is kept alive and healthy, swimming normally until one of the bait is to be selected for use, typically to be hooked on a line of a fishing rod or pole being used by a fisherman or fisherwoman. Though, in some instances, the live well may be removable, it is a major undertaking to remove it. The combination, described herebelow, of a bait-retrieval apparatus operatively disposed within a live well, is designed to be an integral part of the boat, and the live well is not portable.

### BACKGROUND OF THE INVENTION

The purpose of a “live well” also referred to as a “well” for live bait, is not only to maintain the bait in a lively condition, but also to ensure that the bait, whether a single small bait fish such as ballyhoo, runners and the like, or small squid, or shrimp, (individually and collectively referred to herein as “bait”) can be readily, easily and speedily retrieved, manually, often under exigent conditions encountered when fishing in heavy seas. Dealing with heavy seas typically requires a relatively large fishing boat, referred to as an “off-shore” boat or “sport-fishing boat”, which is not only well-equipped for fishing, but also well-appointed for the convenience and comfort of the persons in the boat. Popular boats, which are manufactured and sold under the Sailfish® and Contender® trademarks, range in size from about 7.6 m (25 ft) to 12.2 m (40 ft) in length.

In the following description, the term “well” is used to refer to the live well simply because, on an off-shore boat, the term is commonly used to refer to a live well. In the particular instance where the boat is to be used in a fishing contest, qualifying for a prize successfully demands the use of “fresh and lively” bait which, when deployed in the water, belies the fact that it has a hook in it.

A well in an off-shore boat is typically relatively large so as to hold several dozen bait, whether fish, squid or shrimp, all of which are to be kept alive and in prime health with one or more water-circulating pumps, preferably with aerators and associated filters, until the bait is to be hooked and cast into the water. Circular wells are typical, though some are elliptical or generally rectangular, depending upon the availability of space in the boat. Generally rectangular wells have rounded corners to allow for reliably molding of the well.

Some wells have a removable lid which, when removed, exposes the body of the well. In a circular well, the body may have a diameter near the periphery which is from about 2.5 cm-5 cm (1″-2″) greater than the diameter near the bottom to provide the requisite release from the mold forming the well. Other wells have a covering over the body of the well which is non-removable, the covering having a relatively smaller opening than the cross-section of the body of the well, the smaller opening providing access for a net to scoop up bait. The smaller opening is provided with a removable cover. Non-circular wells, may analogously, removable lids which cover the body of the well, or built-in non-removable covers provided with small openings with removable lids.

To supply a fisherman with a single bait under contest conditions, it is critical that the structural components of the live well and the manner in which they interact be designed so as to allow a fisherman to choose a bait from those swimming around in the well, under conditions which require that only one of his hands be used to pick out a bait, because typically he is holding his fishing rod in the other hand. Until now, selecting a bait is a function discharged by a fisherman using a “bait net” to scoop up several bait from the well, select one, and return the remaining bait to the well. When the number of bait remaining, after many hours of fishing, dwindles down to only a few swimming around frantically in the well, trying to avoid capture, the task of netting a bait becomes challenging and time-consuming. Though the fisherman, fishing under tournament conditions pays a time and convenience penalty for laying down his rod while attending to retrieving bait from the well, at present there is no alternative.

### The Problem:

Having to scoop up bait from within the body of a relatively large live well which is built into an off-shore boat requires freeing both hands, first to raise the lid on an opening in the covering which is typically built-in over the body of the live well, then pick up a short-handled “bait-net” and trap bait against the side of the live well and scoop them up. The difficulty of netting a bait increases as the number of bait remaining in the live well decreases. Frustration increases as the time it takes to net a bait increases. After snaring a bait in the net, while holding the net in his hand, a fisherman is required to use his free hand to remove the bait from the net, put the net down and hook the bait.

### The Solution:

The live well is provided with a vertically reciprocable perforated “catcher”, referred to as a “colander” herein, to present the fisherman with bait at near or above the surface of the water in the well. By “near” refers to a distance less than about 5 cm (2″), preferably less than 2.5 cm (1″), below the surface of the water in the well. The colander is telescopably deployed for up-and-down movement on a support member within the live well, from a “down” position near the bottom of the well, to a “raised” position at near or above the surface of the water in the well. When in the raised position, bait is caught on the colander, where it is presented near the surface of the water. The bait can freely move on the colander but cannot swim freely enough to avoid being manually captured for use.

### SUMMARY OF THE INVENTION

A live well of arbitrary internal cross-section and depth, is provided with a bait-retrieval assembly constructed with commonly available components of fluid systems, which assembly provides an unexpectedly functional retrieval mechanism in a live well from which a bait of choice is readily captured using one hand only. The retrieval assembly comprises a dish-shaped or bowl-shaped colander supported on a fluid-actuated telescopable support member which is hydraulically raised by pumping water into the telescopable support member so that it is extended; and after the bait is removed, water from within the support member is discharged to lower the colander into the bottom of the well.

The phrase “telescopable support member” refers to an assembly of telescopable members of arbitrary cross-section which form the support member. Preferred are hollow cylinders telescopable in a base member including a base cylinder. The phrase “support assembly” refers to the telescopable support member including a mounting plate and a colander. When the support member is extended, the innermost cylinder which is capped on top, is raised into the topmost position.

Intermediate cylinders are open at both ends and movably interfitted in fluid-tight engagement relative to each other so as to present the colander at a desired height in the well.

The colander is a foraminous, generally planar dish-shaped or bowl-shaped (concavo-convex) plate adapted to be secured, preferably removably, on top of the support member. The term “dish-shaped” refers to a colander having a base with a relatively large radius, sufficient to provide a visibly concave (for this purpose) perforated plate or base, the periphery of which rises with an outward flare; the term “bowl-shaped” refers to a colander having a relatively smaller radius which provides a distinctly bowl-shaped plate or base, at the periphery of which a generally vertical wall flares outwardly. The colander is dimensioned so that its periphery is closely adjacent the periphery of the internal walls of the well. When the colander is raised, continued hydraulic pressure exerted within the support member maintains it in the raised position.

Though a planar perforated plate would serve the basic purpose of the catcher, a colander's concave shape serves to concentrate the bait in the center, making it easier to capture one, particularly if there are only a few bait left in the live well. After a bait is selected, the hydraulic pressure is released and the colander returns to its “down” position near the bottom of the well, preferably urged down by a spring means, preferably an elastic tensioning means such as an elongated elastomeric member exemplified by one or more rubber bands exerting a downward pulling force.

By a “colander dimensioned so that its periphery is closely adjacent the periphery of the internal walls of the well” is meant that the width of the space between the periphery of the colander and the internal surfaces of the walls of the well is so small that bait cannot escape through the space.

In those instances where the live well is provided with a hinged lid covering an opening in the top of the well, which opening has dimensions substantially smaller than the diameter of the colander, so that the colander cannot be inserted into the well, the colander is partitioned or sectioned. Each part of a multi-part colander is adapted to be inserted through the opening. The parts of the colander are then assembled inside the well, and secured on top of the support member,

In one preferred embodiment, the well is provided with means for illuminating at least the upper portion of the well, preferably the entire well and its contents, to allow a fisherman to inspect bait on the colander when it is in the raised position.

### BRIEF DESCRIPTION OF THE DRAWINGS

The foregoing and additional objects and advantages of the invention will best be understood by reference to the following detailed description, accompanied with schematic illustrations of preferred embodiments of the invention, in which illustrations like reference numerals refer to like elements, and in which:

FIG. 1 is a schematic illustration of a typical live well in an off-shore boat, the live well having been equipped with a telescopable assembly.

FIG. 2 is a schematic illustration of a first embodiment of a fluid control circuit including valves, used to raise and lower the colander, the control circuit including an orifice and check valve outside the live well.

FIG. 3 is a schematic illustration of a second embodiment of a fluid control circuit including valves, used to raise and lower the colander, the control circuit including an orifice and check valve outside the live well.

FIG. 4 is a perspective view of the telescopable support member and a mounting plate to which a colander is to be removably secured; the support member is in the collapsed or “down” position when its hollow, telescopable, cylindrical members have settled into the hollow base after water is removed from within; in this first embodiment, elastic tensioning members, on either side of the telescopable cylinders, pull the mounting plate downwards with sufficient force to prevent the cylinders being extended during normal operation when the well is being supplied with fresh feed water.

FIG. 5 is a cross section elevational view of the telescopable support member, in its raised position, showing how the hollow telescopable cylinders are arrested at the upward limit of each.

FIG. 6 is a cross section elevational view of the telescopable support member, in its raised position, showing a second embodiment in which the elastic members attach the base of the base cylinder to the mounting plate, interiorly of the hollow telescopable cylinders.

FIG. 7 is a detail view of one embodiment of an inner cylinder stopped against an outer cylinder, showing the mutually interfering means for effecting the stop.

FIG. 8 is a detail view of another embodiment of an inner cylinder stopped against an outer cylinder, showing the mutually interfering means for effecting the stop.

FIG. 9 is a top perspective view of an integral circular colander which is inserted into a cylindrical live well before it is closed with a removable cover.

FIG. 10 is a top perspective view of a multi-part, specifically two-part, circular colander, the two parts of which are inserted into a well having an integral non-removable cover with an opening too small for insertion of an integral colander.

FIG. 11 is a top perspective view of a multi-part (two-part) rectangular colander, the two parts of which are inserted into a well having an integral non-removable cover with an opening too small for insertion of an integral colander.

FIG. 12 is a perspective view of the cylindrical live well, with the cover off, prior to having the telescopable assembly lowered into the well and the colander secured to the mounting plate of the assembly, showing an orientation guide which prevents rotation of the colander.

### DETAILED DESCRIPTION OF PREFERRED EMBODIMENTS

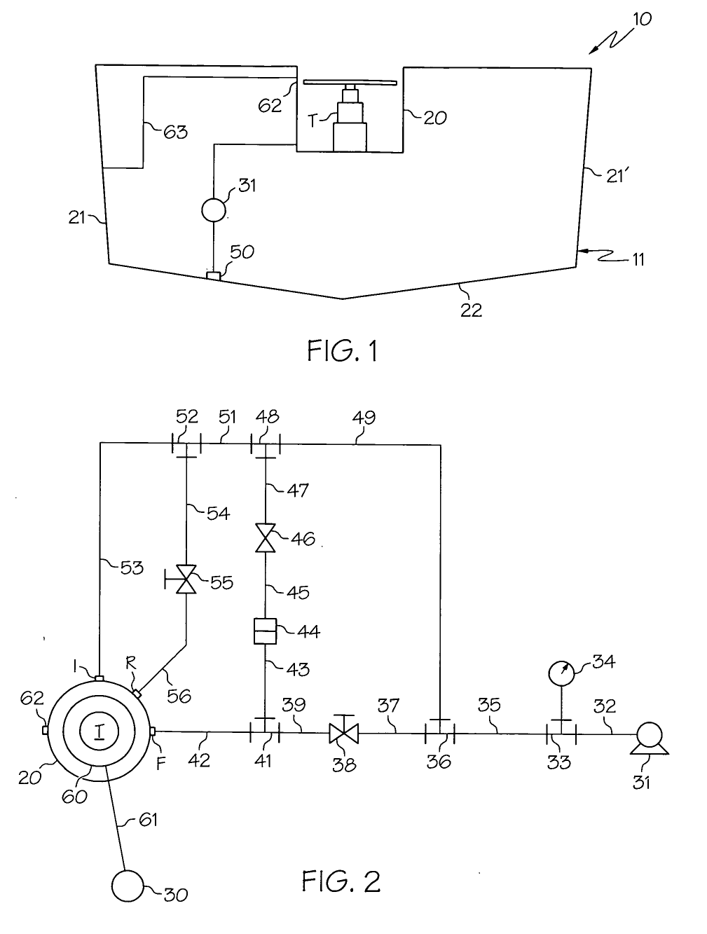

Referring to the various Figures in the drawing, and more particularly to FIG. 1 there is illustrated the hull 11 of a boat 10 in which a live well 20 is built in, typically by being molded into the top liner of the boat, or into the upper portion of the transom of the boat. The well 20, as shown, is generally cylindrical with enough of a taper to provide release from the mold forming the well. Typically the taper is such that the diameter at the bottom is about 2.5 cm (1″) smaller than that at the periphery. The well, as shown, is provided with a removable lid which, optionally, may be hinged. The transom and well cavity are preferably molded from high density polyurethane foam sandwiched between sheets of glass fiber reinforced polyester resin. The installation, and optionally aerated, operation of a live well, per se, is found on commercially available sport-fishing boats. Though the bait retrieval assembly disclosed herein is most preferably installed in a boat's live well before the boat is sold, the live well may be readily retrofitted with the bait retrieval system afterwards.

FIG. 1 schematically shows a cross-section of the hull 11 and the live well 20 having sidewalls 21, 21′ and a bottom 22 is integrally molded into the transom to form a cavity of desired dimensions for use as the well. The well is typically positioned near the longitudinal centerline of the hull to minimize any imbalance that from 75.7 L (20 gal)-189.25 L (50 gal) of water in the well, with bait in water, may cause. A pump 31, such as a Shurflow Model 2088-732-264 rated at 3.41 L/min (12.9 gpm U.S.) at 112.6 KPa (3.1 psi), draws fresh water from the river, lake or ocean through a fresh-water intake port 50 and delivers the water to near the bottom of the well 20. Preferably, an aerator (not shown) is also provided. An overflow line 63 is connected to an overflow port 62 near the top of the well cavity to drain water from the well to the outside of the hull 11. Details of the fluid control system of this invention are provided in FIG. 2 et seq.

If two live wells are provided, a first well is positioned on one side of the longitudinal center line, and the second, is oppositely disposed at a like distance from the same center line. Each well may have its own fluid control system, or the two wells may be interconnected so as to use the same pump and preferably an aerator and filter, and the same electrical power supply.

Live wells in off-shore boats are typically circular in cross-section though they may also be elliptical or polygonal, depending upon the space available in the boat. Polygonal wells are typically either rectangular or square. In the bait retrieval assembly described herein, a cylindrical well 20 is fitted with a colander having a perforated or porous base member, vertically slidable within the well. In use, the well is filled with water to a desired level, and the level is maintained by a supply of fresh water, sufficient to keep the bait alive and in good health, the excess water being removed as overflow and discharged through a drain. Preferably, the water in the well 20 is adequately aerated with an aerator 30. The well is usually provided with a central opening 23, which is covered with a substantially rigid cover, not shown. The opening is at least large enough to allow a person's closed hand or fist to go through the opening to pick out a bait, and typically is large enough to allow a bait-catching scoop-net to be inserted through the opening.

Typically, the tank is hydraulically coupled with at least one pump 31 which supplies the well 20 with water taken from outside the hull. Preferably, in addition one or more aerators 30 provide air through a sparger 60 fed by an air tube 61 (see FIG. 2) which feeds air into the well 20 to oxygenate the bait. Conventional valves and electrical controls are used to control the function of pump and aerator to ensure that the requisite amount of fresh water is delivered to the well, and that the water discharged from within the telescopable member T is removed and returned to the well 20 with the fresh water feed.

There are numerous variations of systems to provide a well with water and air, one manufacturer of boats preferring one system over another, but most are reliable systems which have stood the test of time, and are well known. Any of the existing wells may be modified and retrofitted with the bait retrieval system disclosed herein, though it will be evident that the system is most preferably installed by the manufacturer of the boat when the hull is readily accessible and the fluid lines, valves and electrical connections can be conveniently and easily installed.

### First Embodiment of Fluid Control System

### Orifice Outside Live Well

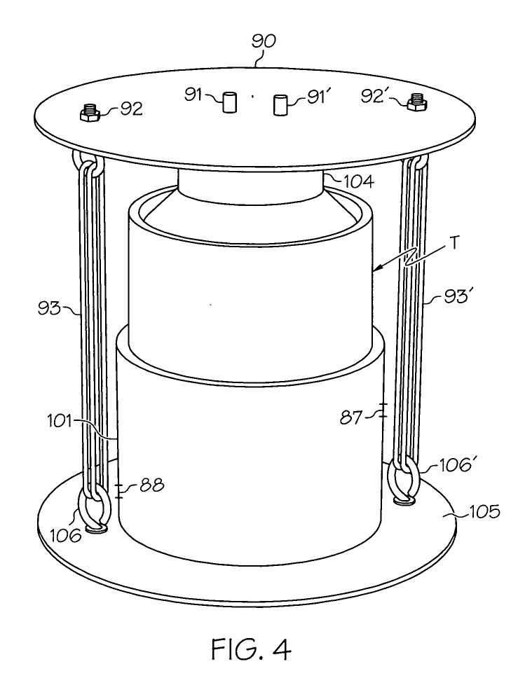

Referring to FIG. 2, there is schematically outlined the components of a first embodiment of water-control system which delivers fresh water to the well 20 in which the telescopable support member “T” with a mounting plate 71 (see FIG. 4) and colander (see FIG. 8) centrally disposed within the well. For economy and ease of installation, all conduit connecting the components may be an inert synthetic resin (“plastic material”) not affected by prolonged contact with either fresh or salt water; e.g. conduit such as flexible poly(vinyl chloride) (“PVC”) “tubing” having a nominal diameter in the range from about 12.7 mm (0.5″) to 2.54 cm (1″). However, for boats to be used in salt water, it is preferred to use composite chlorinated poly(vinyl chloride) (“CPVC”) pipe having an aluminum conduit sandwiched between inner and outer CPVC conduits. Such composite CPVC pipe, though normally rigid, is flexible and can be bent to conform to the inner surface of a boat's hull, and the bent pipe retains its bent shape.

As would be expected, using CPVC pipe requires planning the layout of the piping system with due care so that the resulting installation within the hull is desirably elegant. For ease and convenience, in the description of the fluid control systems herein, the conduit is referred to as “pipe” irrespective of whether it is flexible or rigid, and all components of the system stated to be “connected” with pipe, are in fluid-tight connection. It will be understood that details of the connections described hereunder will vary depending upon the layout of the components of the fluid control system in different boats.

Pump 31 is a delivery pump such as one usually provided for the live well 20 in a boat not equipped with the novel fluid control system, but which pump 31 is now also used in the novel fluid control system. The effluent from pump 31 flows through pipe 32 into an in-line port of tee 33; a pressure gauge 34 is secured in the right angled port of tee 33, and one end of a pipe 35 is connected to the other in-line port of the tee 33. The other end of pipe 35 is connected to an in-line port of tee 36, through the other inline port of which, pipe 37 is connected to a first open/closed solenoid valve 38 from which a pipe 39 is connected to an in-line port of tee 41.

One end of a pipe 42 is connected to the other in-line port of tee 41 and the other end of the pipe 42 is connected to a feed nozzle F through which fresh water is fed to the well 20. Pipe 43 connects the right-angled port of tee 41 to the inlet of a cylindrical barrel 44 having a vertical orifice plate in which an orifice of chosen diameter is provided to adjust the back pressure in pipe 45 which connects the barrel 44 to a check valve 46. The back pressure increases when both solenoids are closed, the telescopable support member is in its fully extended position, and the pump is momentarily dead-headed.

The check valve 46 opens towards the orifice. Pipe 47 connects the check valve 46 to the right-angled port of tee 48, the in-line ports of which are connected with pipes 49 and 51, to the right-angled port of tee 36 and to an in-line inlet port of tee 52, respectively. The other in-line port of tee 52 is connected with pipe 53 to the inlet nozzle I, near the bottom of the well 20 for internally pressurizing the telescopable support member T, to extend it upwards.

The right-angled port of tee 52 is connected by pipe 54 to a second open/closed solenoid valve 55; and pipe 56 connects the solenoid valve 55 to a return nozzle R near the bottom of the well 20.

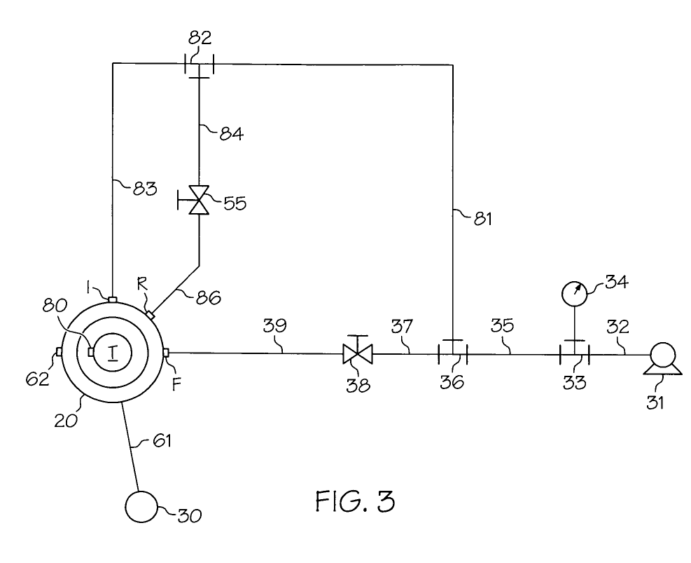

In normal, basic operation of the well, that is, feeding fresh water to it, power is supplied to the pump 31, as it continuously will be, as long as there is live bait in the well. The reading on the pressure gauge 34 during normal operation is preferably in the range from 13.8-68.9 KPa (2-10 psig). Under this pressure, the telescopable support member T is in the collapsed or “down” position, the top being held down with sufficient force by elastic members (see FIG. 3) to prevent flow of fresh water through pipes 49, 47 and 51. This forces the flow through pipe 37. No current is supplied to the first and second solenoid valves, 38 and 55 respectively, and both are open. Fresh water flows through the path of least resistance, and essentially all the water flows through pipe 37, open first solenoid valve 38, then through tee 41 and pipe 42 into the feed inlet nozzle F. Overflow from the well 20 flows out of an outlet port 62 near the top of the well, and the port 62 is typically blocked with a wide-meshed screen (not shown) to prevent bait from escaping through the outlet port.

When the telescopable support member T is to be extended (the colander raised), a switch (not shown) is closed to provide electrical current to close both first and second solenoid valves 38 and 55. Flow of water is now only through pipe 49, then through the in-line ports of tees 48 and 52, and into the inlet nozzle I until the telescopable support member T is extended to its maximum height against a stop, and the pump is momentarily dead-headed. At this point, the pressure increases so as to back up and divert flow of water through the right-angled port of tee 48, pipe 47 and opened check valve 46 so as to flow against the orifice plate where the back pressure is controlled by the diameter of the orifice, this back pressure being sufficient to maintain the extended or “raised” position of the telescopable support member T but not sufficient to damage its sealing members. The diameter of the orifice is in the range from about 3.18 mm (0.125″) to about 9.52 mm (0.375″) depending upon the size Water flowing through the orifice is fed through tee 41 and pipe 42 into the feed inlet nozzle F.

After a bait is chosen, current to the first and second solenoids is switched off to open both of them causing the telescopable support member T to collapse, to lower the colander with remaining bait into the well, and to resume normal operation of feeding fresh water to the well. As will be explained in greater detail below, elastic members pull downwards on the raised telescopable support member T to overcome the pressure exerted by the head of water in the well on water inside the support member T. Water expelled from within the member T is discharged through return nozzle R, through open second solenoid valve 55 and the right-angled port of tee 52 through which it flows and is then mixed with fresh water flowing into feed inlet nozzle F.

The aerator pump 30 is connected through pipe 61 to a sparger 60 in the bottom of the well 20 through which sparger air is continuously supplied to the well.

### Second Embodiment of Fluid Control System

### Orifice in Support Member

Referring to FIG. 3, there is schematically outlined the components of a second embodiment of a water-control system to serve the same purpose as the one detailed above in FIG. 2, though this second embodiment dispenses with the use of a check valve and an orifice in a plate exteriorly located relative to the well. The orifice is now located in the wall of a hollow cylinder of the support member, preferably the topmost cylinder. The relocated orifice functions in an analogous manner to relieve the pressure within the extended support member when the topmost cylinder is fully extended and the pump is temporarily dead-headed.

In a manner analogous to that described in FIG. 2, delivery pump 31 pumps water drawn through intake port 50 in the bottom 12 of the hull, and discharges the water through pipe 32 into an in-line port of tee 33; a pressure gauge 34 is secured in the right angled port of tee 33, and one end of a pipe 35 is connected to the other in-line port of the tee 33. The other end of pipe 35 is connected to an in-line port of tee 36, through the other inline port of which, pipe 37 is connected to a first open/closed solenoid valve 38 from which a pipe 39 is connected to feed nozzle F through which water is fed to the well 20.

One end of pipe 81 is connected to the right-angled port of tee 36 and to an in-line inlet port of tee 82. The other in-line port of tee 82 is connected with pipe 83 to the inlet nozzle I, near the bottom of the well 20 for internally pressurizing the telescopable support member T, to extend it upwards. The right-angled port of tee 82 is connected by pipe 84 to the second open/closed solenoid valve 55; and pipe 85 connects the solenoid valve 55 to a return nozzle R near the bottom of the well 20.

In this second embodiment, fresh water is fed to the well as before, and because the support member T is held in the “down” position to prevent flow of water through pipe 49, water is forced to flow through pipe 37 and solenoid valve 38 which is open as no current is supplied to either the first or second solenoid valves. Essentially all the water flows through pipe 37, solenoid valve 38, then through pipe 39 into the feed inlet nozzle F. As before, overflow from the well 20 flows out of an outlet port 62 near the top of the well.

When current is supplied to first and second solenoid valves 38 and 55, both are closed and the support member T is extended. Flow of water is now only through pipe 83 into the inlet nozzle I until the telescopable support member T is extended to its maximum height and the pump momentarily dead-headed. As the pressure against the dead-headed stop increases, water is ejected from one or more orifices in the topmost hollow cylinder to relieve the pressure while a bait is being selected from the colander near the surface of the water in the well.

After a bait is chosen, current to the solenoids is switched off to open both of them. Under the downward pressure exerted by the elongated elastic member, water is ejected through the orifice(s) as well as from the bottom of the support member T through return nozzle R. The water is returned through open second solenoid valve 55 and the right-angled port of tee 82 through which it flows and is then mixed with fresh water flowing into feed inlet nozzle F.

Referring to FIG. 4, telescopable support member T is shown in the “down” or collapsed position. The cross-section of each member of the telescopable support member is arbitrary, provided successive members are telescopable. Preferred telescopable members are hollow cylindrical members, and at least one is necessary. Several are preferred, and shown are members 102, 103 and 104 shown collapsed into a base member provided with a cylindrical portion 101. The base member is provided with inlet and outlet ports 87 and 88 respectively, in its lower portion. The top of the innermost cylinder 104 is capped. It is visible under the mounting plate 90 which is positioned over a pair of threaded studs or dowel pins 91, 91′ protruding from the upper surface of the cap of cylinder 104.

The mounting plate 90 has a pair of attachment rings 92, 92′ welded or otherwise secured to the plate's lower surface to provide attachment for one end of each elastic member 93, 93′. The base member 101 is positioned on a base plate 105 having a pair of oppositely disposed attachment rings 106, 106′ welded or otherwise secured to it, to provide attachment for the other end of each elastic member 93, 93′. After a bait is selected from the colander, and it is to be lowered after the feed pump ceases to exert fluid pressure within the assembly, the elastic members together provide enough tensile force on the mounting plate to force water out from a port within the support member; but the tensile force is not enough to lower the colander when the feed pump pressurizes the fluid within the support assembly.

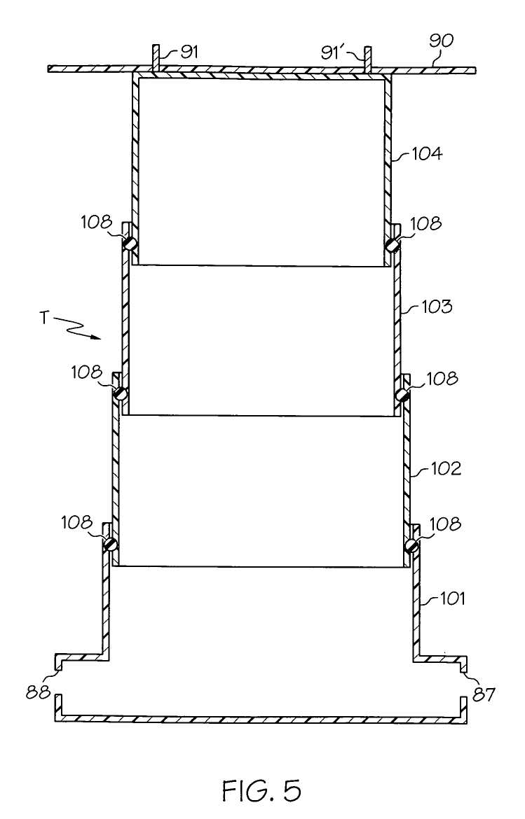

Referring to FIG. 5, telescopable support member T is shown in the extended position, using plural nesting hollow cylindrical members 101, 102, 103 and 104 of the member referred to generally by the letter “T”. The generally cylindrical base member comprises a fixed cylindrical member 101 in a unitary molded base having inlet and outlet ports 87 and 88 respectively. Peripheral sealing means, such as O-rings 108 allow cylindrical member 102 to be movably interfitted in fluid-tight relationship within member 101, and the other two cylindrical members movably interfitted in fluid-tight relationship with member 102 and one another. Though three movable cylinders are illustrated, it will be appreciated that the number of cylinders used will be, in part, dependent upon the height to which the member T is to be extended, and the height desired after it is collapsed. At least one movable cylinder is always used.

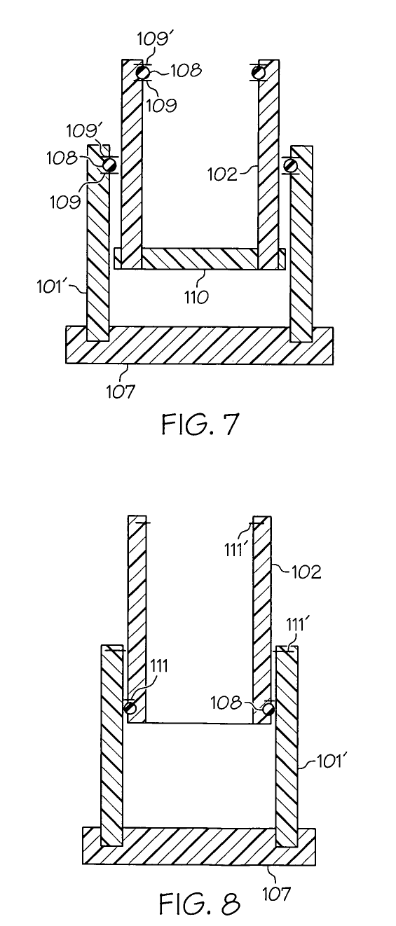

Details of a first embodiment of the sealing relationship between movable cylinders wherein the inner cylinder 102 is stopped against an outer cylinder 101′ by mutually interfering means to stop upward movement of cylinder 102 is illustrated in FIG. 7 wherein a cap 107 is threadedly secured to cylindrical member 101′ and the cap functions as the base. Near the rim of member 101′ an O-ring 108 is confined between snap rings 109, 109′, all being fitted in grooves cut in the inner surface of member 101 so as to protrude beyond the inner surface. Cylindrical member 102 is slidably loosely disposed within member 101. A cylindrical collar 110 is secured near the lower periphery of member 102, preferably by threading it onto grooves cut in the periphery. The outside diameter of the collar is adapted to provide a sliding fit within member 101.

To place the collar 110 onto the member 102, cap 107 is removed and member 102 is pushed through the O-ring 108 against which the outer surface of member 102 is tightly pressed, and through the bottom of member 101′. The collar 110 is threaded onto member 102 and the assembled collar 110 and member 102 are pushed into member 101. The cap 107 is then replaced on member 107.

When fluid pressure urges member 102 upwards, the collar 110 is stopped against the lower snap ring 109.

In a second embodiment illustrated in FIG. 8, the O-ring 108 is fitted in a groove provided in the inner member 102, near the lower periphery thereof, and a snap ring 111 fitted in a groove just above the O-ring. Another snap ring 111′ is fitted in a groove cut in the upper periphery of the inner surface of member 101′ so as to stop the upward movement of the member 102 under fluid pressure. Member 102 is stopped when snap ring 111 contacts snap ring 111′. To stop the next inner member 103 (not shown) after is inserted into member 102, a snap ring another snap ring 111′ is fitted into a groove cut in the upper periphery of the inner surface of member 102 so as to stop the upward movement of the member 103 (not shown) under fluid pressure.

To assemble member 102 within member 101′, the cap 107 is removed and snap ring 111′ fitted in the unthreaded upper end of member 101′; then member 102 is thrust through member 101′ and the snap ring 111 and O-ring 108 fitted in their grooves. The lower end of member 102 is then thrust back into member 101′. Additional movable members 103 and 104 are analogously assembled.

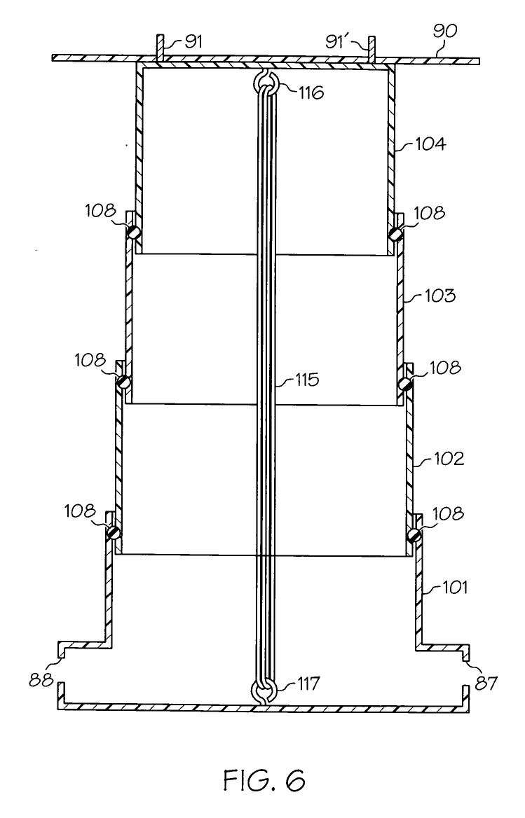

Referring to FIG. 6 there is shown a second embodiment of the support assembly in which an elastic tensioning member 115 attaches the cap of the topmost cylinder 104 to the base of cylindrical member 101. A swivel ring 116 is provided under the cap of the topmost cylinder 104; and another swivel ring 117 is provided on the inner surface of the base of member 101. One end of an elastic tensioning member 118 is attached to swivel ring 116 and the other end of the member 118 is attached to swivel ring 117.

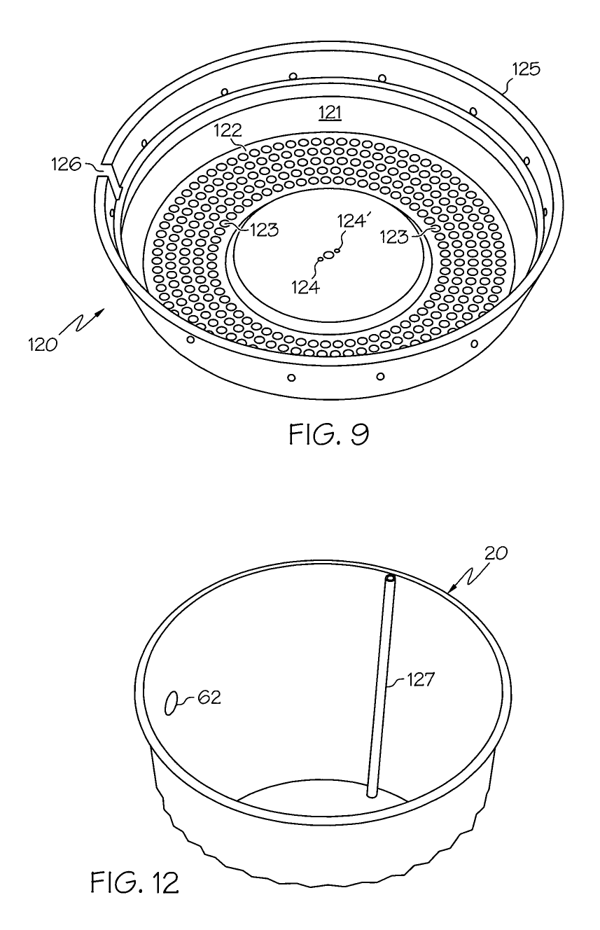

Referring to FIG. 9, an integral circular colander 120 to be inserted in a cylindrical live well 20, comprises a bowl-shaped member 121 having a perforated base 122 having perforations 123, generally in the range from about 6.35 mm-19.05 mm (0.25″-0.75″) in diameter, the holes being too small for passage of bait to be presented on the colander. The base is provided with through-apertures 124 and 124′ corresponding in location to the spacing of the dowel pins or threaded studs 91, 91′ of the mounting plate so that the base may be secured to the mounting plate with rivets, nuts or other fastening means.

The colander may be essentially rigid when the support assembly is to be placed in a substantially cylindrical well having inner diameters near the bottom and near the top which are less than 12.7 mm (0.5″) different from one another, because the annular space between the periphery of the colander and the wall of the well is small enough to impede escape of the bait around the colander.

Because a typical well is tapered from top to bottom, the top having a diameter about 2.54 cm (1″) greater than at the bottom, the periphery of the colander's base 122 is preferably provided with a circumferential generally vertical outwardly flaring continuous flexible skirt 125 having a radial width sufficient to be closely adjacent, and preferably engage, the inner wall of the well 20 from near its bottom to near its top. When the well is generally rectangular and tapered, the colander is provided with a peripheral, generally vertical, continuous skirt projecting outwardly, to be closely adjacent, and preferably engage, the inner wall of the rectangular well from near its bottom to near its top and The skirt 125 may be integrally molded with the bowl-shaped base 122, or it may be secured to the periphery of the base by appropriate fastening means such as rivets (not shown).

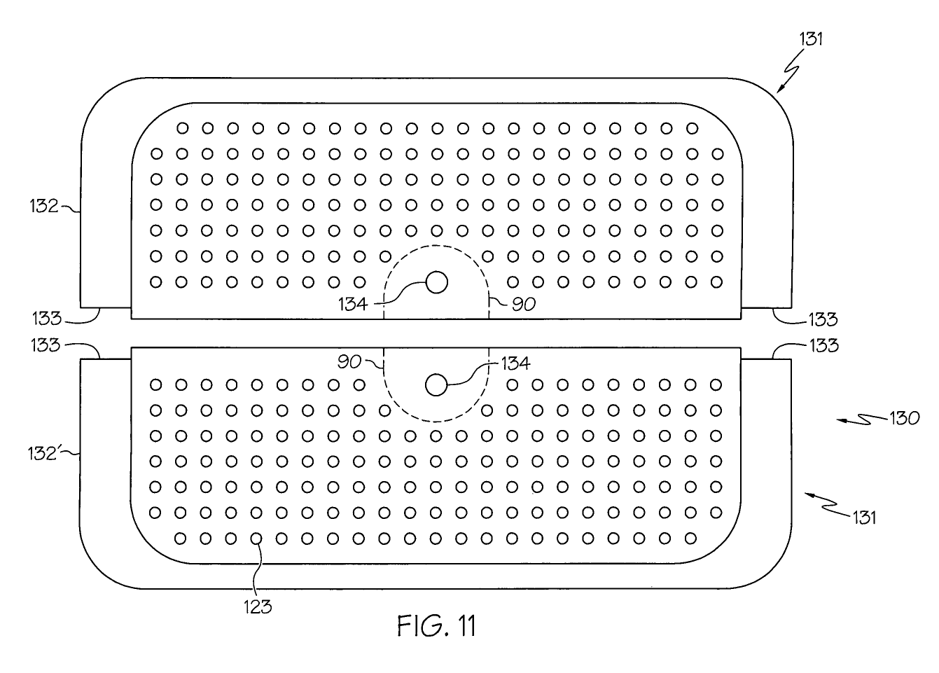

It will be appreciated that when the colander is raised and lowered on the support assembly, the orientation of the colander is not fixed. Despite the tensioning means which connects the mounting plate and fastening means by which the colander is secured to the top of the innermost cylinder, the colander is prone to random rotation. To prevent such rotation, a vertical slot 126 is provided in the skirt 125, and the width of the slot is dimensioned to slidably accommodate a guide bar 127 (see FIG. 11).

In those instances where the body of a circular or elliptical well has cross-sectional dimensions larger than the dimensions of the opening in the covering of the well, for example when the well is covered with a molded-in, non-removable cover having an opening with dimensions which prevent insertion of a rigid, that is manually, substantially non-deformable, colander whether it is circular, elliptical or rectangular, the colander may be flexible. By “flexible” is meant that the colander is molded of a synthetic resin in a thickness such as to provide sufficient flexibility to bend the colander around its longitudinal axis sufficiently to permit insertion of the colander through the cover, whether the colander is bowl-shaped, circular or elliptical, or generally rectangular. In those instances where a substantially rigid colander cannot be inserted through the opening in a built-in, non-removable cover of a well, it is preferred to section a rigid colander and assemble the sections within the well.

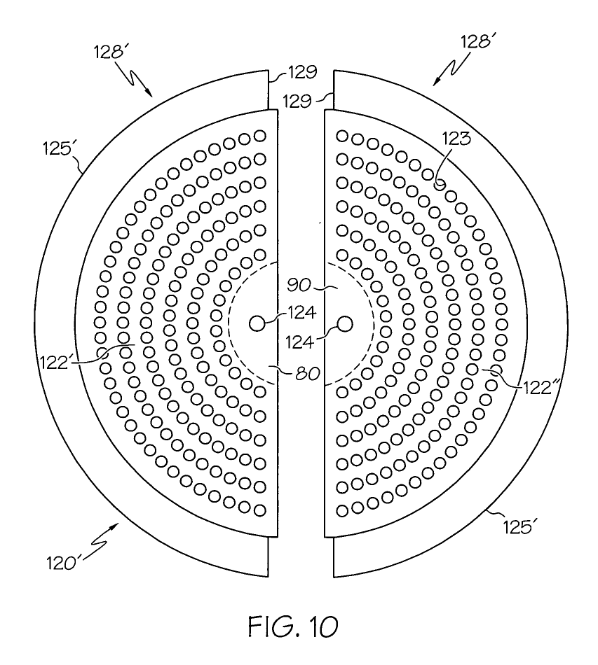

Referring to FIG. 10, there is shown a plan view of a circular colander similar to the one described in FIG. 9 above, except that the colander is sectioned into two parts 128 and 128′, along its centerline, for ease of insertion of each part separately, into a well having an opening with a diameter smaller than that of the colander. Preferably the halves 128, 128′ are formed by cutting along a line which bisects vertical slot 129 which is formed when the halves are assembled and secured with fastening means such as rivets or screws on the mounting plate 90. An elliptical colander would be similarly sectioned and reassembled. A large live well may require a colander to be sectioned into three or more parts for ease of assembly.

Referring to FIG. 11, there is shown a plan view of a generally rectangular colander 130 as opposed to the circular ones described in FIGS. 8 and 9 above, this colander being sectioned into two parts 131 and 131′, along its centerline, for ease of insertion into a rectangular well having an opening with dimensions which will not permit insertion of a rigid rectangular colander. Each half is provided with a generally vertical flexible skirt 132 which flares outward to be closely adjacent to, and preferably, engage the walls of a rectangular well. Preferably the halves 131, 131′ are formed by cutting along a line which bisects vertical slot 133 which is formed when the halves are assembled and secured with fastening means on the mounting plate 90.

Referring to FIG. 12 is a perspective view of a cylindrical well 20 having a vertical guide bar 135 secured to its inner wall to guide the vertical movement of colander 120 and prevent its rotation while it is moving when the slot 123 of the colander is positioned over the guide bar.

Having thus provided a general discussion, described the overall live bait bucket in detail and illustrated it with specific illustrations of the best mode of making and using it, it will be evident that the invention has provided an effective solution to an age-old problem. It is therefore to be understood that no undue restrictions are to be imposed by reason of the specific embodiments illustrated and discussed, and particularly that the invention is not restricted to a slavish adherence to the details set forth herein.

What is claimed is:

1. A retrieval assembly to retrieve bait from a live well in a boat, the assembly comprising,
a colander having perforations too small for passage of bait to be presented on the colander, and a periphery closely adjacent to the wall of the well;
a support member having a base member having an inlet port and an outlet port, and including at least one telescopable member having its upper end capped and slidably disposed in fluid-tight communication within the base member;
fastening means for securing the colander to the one telescopable member on the top thereof;
tensioning means connecting the fastening means and the base member, the tensioning means exerting a chosen downward force on the fastening means; and,
an electrically actuated fluid control system comprising a feed pump and valves adapted to pump water into the support member and pressurize it sufficiently to raise the one telescopable member, and to cut off flow to the support member when desired.

2. The retrieval assembly of claim 1 wherein the support member includes plural telescopable cylinders and the one telescopable member is the innermost capped cylinder; and,
the chosen force is insufficient to lower the innermost capped cylinder when it is pressurized by the feed pump, but sufficient to lower the innermost capped cylinder when flow from the feed pump to the support member is cut off.

3. The retrieval assembly of claim 2 wherein the colander includes an outwardly flaring peripheral wall.

4. The retrieval assembly of claim 3 wherein the peripheral wall includes a vertical slot adapted to slidably engage a vertical guide bar affixed to the well's wall.

5. The retrieval assembly of claim 4 wherein the peripheral wall includes a flexible skirt having an outwardly flaring periphery closely adjacent to the wall of the well.

6. The retrieval assembly of claim 2 wherein the fastening means includes a mounting plate on which the colander is removably mounted.

7. The retrieval assembly of claim 2 wherein the fluid control system comprises a first solenoid valve through which feed water is fed to the support assembly;
a second solenoid valve through which feed water is removed from the support member when the innermost cylinder is maintained in the raised position; and,
a check valve upstream of an orifice to control pressure exerted by the water within the support member when it is in the raised position.

8. The retrieval assembly of claim 2 wherein a telescopable member has an orifice therein to relieve pressure exerted by fluid within the support member;
the fluid control system comprises a first solenoid valve through which feed water is fed to the support assembly; and,
a second solenoid valve through which feed water is removed from the support member when the innermost cylinder is maintained in the raised position.

9. The retrieval assembly of claim 5 wherein the colander is circular.

10. The retrieval assembly of claim 5 wherein the colander is generally rectangular.

11. The retrieval assembly of claim 9 wherein the circular colander is a multipart colander adapted to be assembled within the well.

12. The retrieval assembly of claim 10 wherein the rectangular colander is a multipart colander adapted to be assembled within the well.
